(19) United States
(12) Patent Application Publication
(10) Pub. No.: US 2023/0053896 A1
(43) Pub. Date: Feb. 23, 2023

(54) TRACK CLEANING SYSTEM FOR TRACTORS

(71) Applicant: Robert John Haas, Elizabeth, IL (US)

(72) Inventor: Robert John Haas, Elizabeth, IL (US)

(21) Appl. No.: 17/793,613

(22) PCT Filed: Jan. 15, 2021
(86) PCT No.: PCT/US2021/013609

§ 371 Date: Jul. 18, 2022

Related U.S. Application Data
(60) Provisional application No. 62/962,713, filed on Jan. 17, 2020.

(51) Int. Cl. B62D 55/088; B62D 55/065

(52) U.S. Cl. CPC B62D 55/0882; B62D 55/065

(57) ABSTRACT

An off highway vehicle having a plurality of track assemblies for supporting the vehicle for movement over terrains of various conditions. A track cleaning device is mounted on a chassis of the vehicle adjacent a powered roller of the track assembly. Each track cleaning device has an arcuate configured frame for supporting an endless chain assembly for movement in an arcuate path over an axel of the power driven roller of the track assembly for engaging, dislodging, and directing debris from the gap between the respective track assembly and chassis of the work vehicle.

### CROSS-REFERENCE TO RELATED APPLICATIONS

This patent application claims the benefit of U.S. Provisional Patent Application No. 62/962,713, filed Jan. 17, 2020, which is incorporated herein by reference.

### FIELD OF THE INVENTION

The present invention relates generally to off-highway work vehicles, such as tractors, which are supported and move by track assemblies over a wide varieties of terrains.

### BACKGROUND OF THE INVENTION

Such off the highway vehicles are capable of travelling over wetlands, mud, croplands, snow, and ice. In order to increase the vehicle's ability to travel through such terrains, they include track assemblies for driving and/or steering the work vehicle. The use of such track assemblies increases the vehicle's ability to engage the various terrains without losing traction, and thus, enhances the vehicle's performance through such sluggish or slippery conditions.

In such wet field conditions, however, mud, field crop materials, and other debris can be carried by the tracks and accumulate in short time between the tracks and the chassis of the vehicle. This increases resistance to track movement, which in turn increases fuel consumption, and causes wear to the tracks. In some instances, the resistance can cause dry vegetation to ignite into flames. In a relatively short time, such clogging necessitates interruption of the work operation and manual clean out the mud and accumulated debris, which can be difficult and time consuming.

### OBJECTS AND SUMMARY OF THE INVENTION

It is an object of the present invention to provide a track operated work vehicle adapted for more efficient operation in wet, sticky, or other adverse field conditions.

Another object is to provide a track operated work vehicle of the above kind which eliminates labor costs, production downtime, and the inconvenience of cleaning accumulated and clogged mud and debris between the tracks and chassis of the vehicle.

A further object to provide a track operated work vehicle with a track cleaning system operable for maintaining the space between the tracks and the machine chassis free of accumulated mud and debris.

Yet another object is to provide a track operated work vehicle having track cleaning devices that are selectively operable for different field conditions.

Another object to provide a track operated work vehicle with having a track cleaning system as indicated above that is relatively simple in construction and operation and adapted for retrofitting on existing tractors.

Other objects and advantages of the invention will become apparent upon reading the following detailed description and upon reference to the drawings.

### BRIEF DESCRIPTION OF THE DRAWINGS

FIG. 1 is a perspective of an illustrative off the road vehicle having a track cleaning system in accordance with the invention;

FIG. 2 is a schematic of one of the track assemblies of the illustrated track cleaning device, shown in partial perspective for purposes of illustration;

FIG. 3 is a side elevational view of the illustrated track cleaning device;

FIG. 4 is a schematic showing movement of the track cleaning chain assembly about an upper arcuate wall of the housing of the illustrated track cleaning device;

FIG. 5 is a schematic showing movement of the chain about both upper and lower curve walls of the housing of the illustrated track cleaning device;

FIG. 6 is a perspective showing the underside of the illustrated track cleaning device housing and the chain assembly drive motor;

FIG. 7 is a front perspective showing the track cleaning device in relation to the track and chassis of the illustrated vehicle;

FIG. 8 is a perspective of the forward end of the track cleaning device, showing the chain assembly drive;

FIG. 9 is an underside view of the end of the track cleaning device depicted in FIG. 8, showing the train assembly drive motor; and

FIGS. 10 and 11 are perspectives of a chain tensioning mechanism that may be used with the illustrated track cleaning device;

While the invention is susceptible of various modifications and alternative constructions, certain illustrative embodiments thereof has been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE PREFERRED EMBODIMENTS

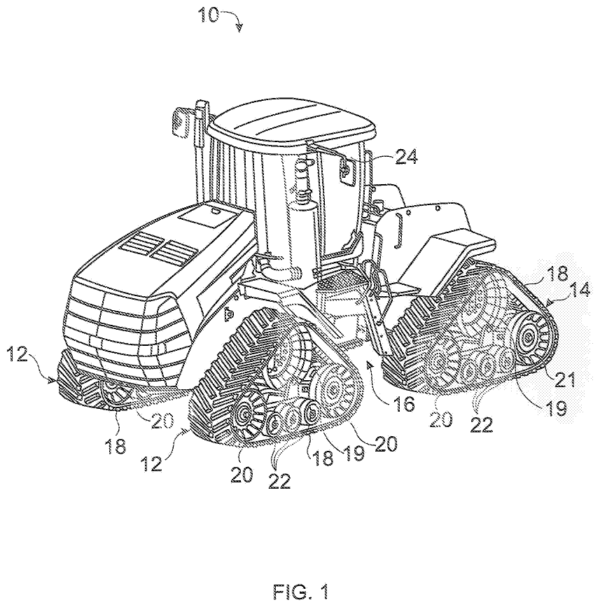

Referring now more particularly to FIG. 1 of the drawings, there is shown an illustrative track operated work vehicle 10 having a track cleaning system in accordance with the invention. The illustrated work vehicle 10, which is configured as an agricultural tractor and as is known in the art, includes a pair of front track assemblies 12, a pair of rear track assemblies 14, and an engine and transmission carrying chassis 16. The track assemblies 12, 14 each include an endless track 18, a drive wheel 19 coupled to the engine transmission, front and rear wheels 20, 21 about which the track 18 operates and a plurality of roller wheels 22 for guiding the track 18 between the wheels 20, 21. An enclosed operator's cab 24 in this case is supported by the chassis 16 and may house various controls for operation of the tractor 10.

As indicated above, when the tractor 10 is operated in wet, sticky or other adverse field conditions, mud and debris can accumulate in a gap 24 between the track 18 and a side wall 25 of the chassis 16 (FIG. 7), impeding movement of the track 18, increasing fuel consumption, and requiring frequent interruption in operation for difficult clean out.

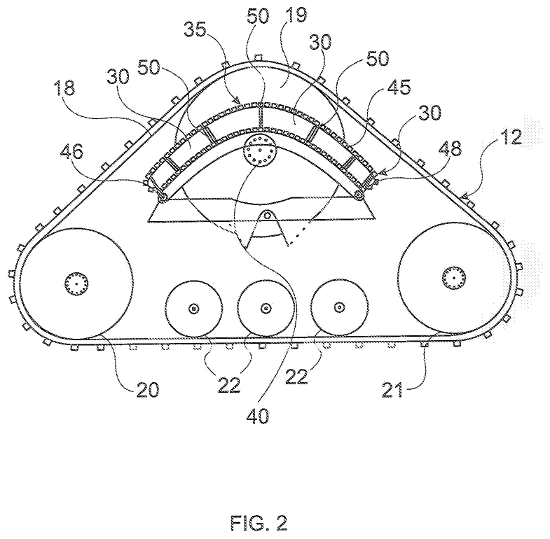

In accordance with the invention, the track assemblies 12, 14 each have respective track cleaning device 30 for preventing the buildup and jamming of mud and debris between the tractor chassis 16 and movable track 18. In the illustrated embodiment, each track cleaning device 30 includes an arcuate configured housing 31 secured to a side wall 25 of the tractor chassis 16 adjacent the track assembly 12, 14 and a power driven endless chain assembly 35 mounted for movement about the housing 31 for engaging, dislodging, and directing mud and debris out of a gap 24 between the movable track 18 and the tractor chassis 16. The housing 31 which may be made of durable plastic such a polyethylene, in this case comprises a pair of curved outer and inner chain guide walls 36, 37 supported by front and rear side walls 38, 39 with the rear side 39 wall being appropriately mounted to the adjacent side wall 25 of the tractor chassis 16. The housing 31 in instance is supported above and curves around an axel 40 (FIG. 2) of the drive wheel 19. The upper curved wall 34 is disposed about midway between the axel 40 and the outer perimeter of the drive wheel 19 and extends beyond forward and rearward sides of the drive wheel 19.

The illustrated chain assembly 38 comprises a pair of link chains 45 disposed in laterally offset relation to each other with each being trained about respective forward and rear sprockets 46, 48 rotatably supported by the housing 31. The illustrated chain assembly 35 has an upper leg chained about and supported for movement on an outer side of the upper arcuate wall 36 and a lower leg supported for movement over the inner curved wall of the housing. The shafts for the sprockets 46, 48 are supported between the housing side walls 38, 39 in appropriate common bearings.

In carrying out a further feature of the illustrated embodiment, the chain assemblies 35 each include a plurality of debris engaging cross links 50 disposed at intervals along the length of the chain assembly between the link chains 45, each designed for engaging and dislodging materials entering the gap 25 between the track 18 of the track assembly and the chassis 16. The cross links 50 preferably have a rectangular or square configuration with sharp corners 50a for effectively engaging, dislodging, and directing debris, and the like as it is drawn into the space adjacent the moving track 18 (FIG. 5).

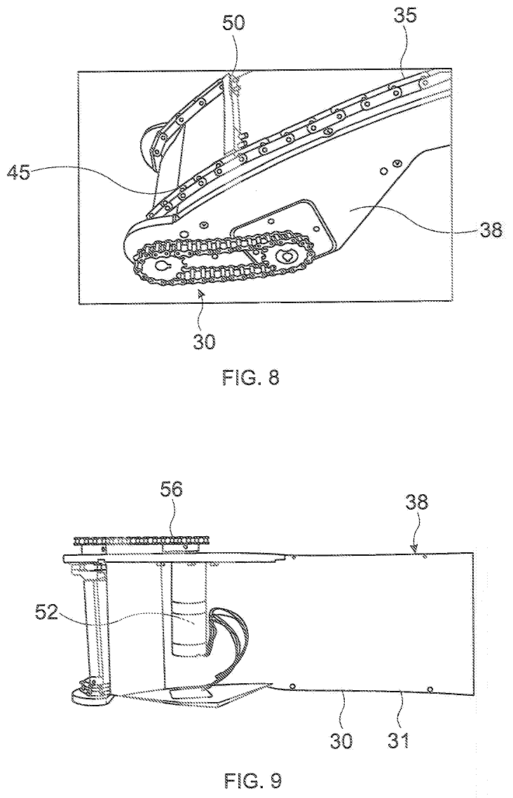

For operating each chain assembly 35, an electric motor 52 (FIG. 9) is supported on an under side of each housing 31 between the side walls 38, 39. The electric motor 52 has a drive shaft that extends through the forward side wall 38 of the housing and carries a drive sprocket 55 (FIG. 4), which in turn drives the forward drive sprockets 46 via chain 56 (FIGS. 8 and 9). The drive motor 52 preferably a 12 volts, brushless variable speed, electric motor which can be controlled from the cab 24 of the tractor for operating the chain assembly 35 at different speed depending upon the condition of the terrain upon which the tractor is being operated. While the chain assemblies preferably are operated for discharging debris in a forward direction movement of the tractor, alternatively, chain assemblies could be operated in a reverse direction.

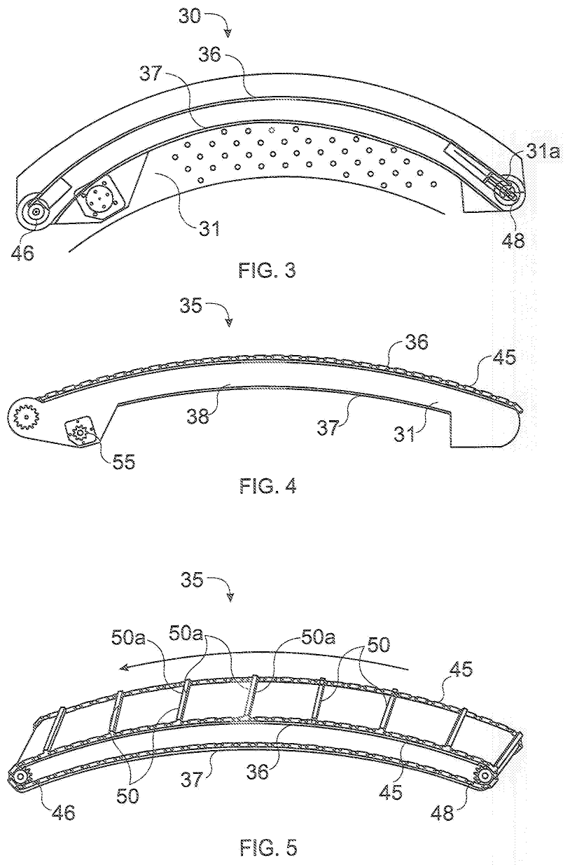

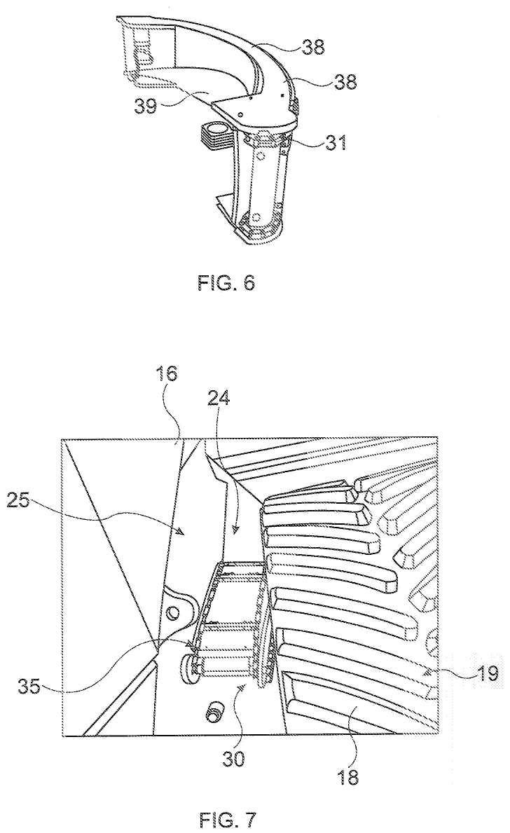

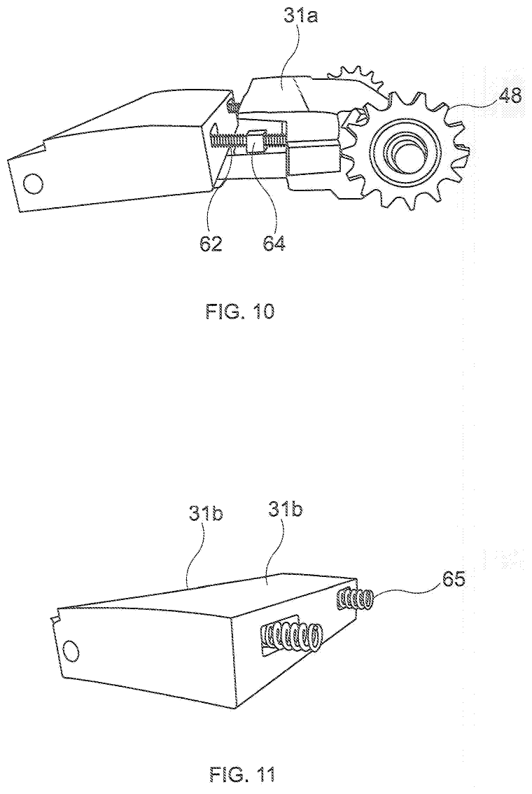

In keeping with a further feature of the illustrated embodiment, each track cleaning device 30 includes a chain tensioning mechanism 60 for maintaining the chain assembly 35 in a taught condition during its travel about the housing 31. For this purpose, the housing 31 includes a forward segment 31a adjustably positionable with respect to a main housing segment 31b. The forward adjustable housing segment 31a, carries the chain drive sprockets 48 and has a threaded shaft 62 (FIGS. 3 and 10) extending rearwardly thereof. The shaft 62 carries an adjustably positionable nut for engagement with a coil spring 65 disposed within the housing segment 31b (FIG. 11), such that upon assembly, the spring urges the forward section 31 in a chain tensioning direction. It will be understood that by adjustable positioning of the nut 64 on the threaded shaft 62 the biasing force can be adjusted.

The dramatic effect of the operation of the track cleaning devices 30 was observed when the tractor 10 was operated over wet terrains with one of the track assemblies having an operational track cleaning device 30 and another of the track assemblies being without such a cleaning device. In a relatively short period, an extensive accumulation of mud and debris buildup between the track 18 and chassis 16 to the extent of impeding track movement, while the track assembly with the track cleaning device remained substantially clean of debris or other foreign matter.

From the foregoing, it can be seen that a track operated work vehicle is provided that is adapted for more efficient operation in wet, sticky, and other adverse field conditions. The work vehicle includes a track cleaning device associated with each track assembly that is effective for maintaining the gap between the moving track and the work vehicle chassis free of clogging mud and debris that can impede operation of the track assemblies and require frequent time consuming cleanout. Yet the track cleaning devices are relatively simple and construction and operation and are adapted for retrofitting on existing off the road vehicles.

What is claimed:

1. An off highway vehicle comprising a chassis containing a drive motor and transmission; a plurality of track assemblies supporting said chassis for movement over terrains of various conditions; said track assemblies each including a plurality of rollers, one of which is powered by said drive motor and about which an endless track is trained for driving movement of the vehicle; a track cleaning device between each track assembly and a respective side of the vehicle chassis; said track cleaning devices each being mounted on said chassis adjacent the powered roller of the respective track assembly; said track cleaning devices each including an endless chain assembly disposed for movement about forward and rear sprockets; and said track cleaning devices each having a motor for driving the chain assembly about the sprockets of the track cleaning device for engaging, dislodging, and directing debris from between the respective track assembly and chassis of the work vehicle.

2. The off highway vehicle of claim 1 in which said track cleaning devices each are mounted above an axel of the powered roller of the respective track assembly.

3. The off highway vehicle of claim 1 in which said track cleaning devices each including an arcuate configured frame mounted on said chassis adjacent a side of the power driven roller for guiding movement of the respective chain assembly.

4. The off highway vehicle of claim 3 in which the arcuate frame of each track cleaning device extends beyond forward and rear sides of the adjacent powered roller of the respective track assembly.

5. The off highway vehicle of claim 1 in which said chain assembly of each track cleaning device includes a pair of link chains having a plurality of cross members disposed between the link chains.

6. The off highway vehicle of claim 1 in which said cross members of each track cleaning device have pointed edges for engaging, dislodging, and directing debris from the gap between said track assembly and chassis.

7. The off highway vehicle of claim 6 in which said cross members of each track cleaning device are rectangular or square in cross sections with corner thereof defining the pointed edges.

8. The off highway vehicle of claim 1 in which said track cleaning devices each including an arcuate configured frame mounted on said chassis to which said sprockets of the track cleaning device are rotatably mounted, said frame of each track cleaning device including upper and lower arcuate walls; said chain assembly of each track cleaning device having an upper leg section movable along an upper surface of the upper arcuate wall of the frame of the respective track cleaning device and a lower leg section movable along an upper surface of the lower arcuate wall of the respective track cleaning device.

9. The off highway vehicle of claim 8 in which said frame of each track cleaning device includes a tensioning mechanism for biasing the chain assembly supported thereon in a taught position

10. The off highway vehicle of claim 9 in which said frame of each track cleaning device has a main section mounted on said chassis having a plurality of said chain supporting sprockets at one end and a relatively movable housing section having a plurality of said chain supporting sprockets at an opposite end of the frame, and said chain tensioning mechanisms each includes a spring mechanism interposed between said main frame section and movable frame section for biasing the movable frame section in a direction that tensions said chain assembly.

11. The off highway vehicle of claim 4 in which the motor of each track cleaning device is mounted on the frame of the respective track cleaning device.

12. An off highway vehicle comprising a chassis containing a drive motor and transmission; a plurality of track assemblies supporting said chassis for movement over terrains of various conditions; said track assemblies each including a plurality of rollers one of which is powered by said drive motor and about which an endless track is trained for driving movement of the vehicle; a track cleaning device between each track assembly and a respective side of the vehicle chassis; said track cleaning devices each having an arcuate configured frame mounted on said chassis above an axial of the powered roller of the respective track assembly; said track cleaning devices each including an endless chain disposed for movement about sprockets rotatably supported at opposite ends of the frame of the respective track cleaning device with said frame supporting the chain assembly for movement in an arcuate path over the axial of powered roller of the track assembly; and said track cleaning devices each having a motor for driving the chain assembly about the sprockets thereof and along the arcuate configured frame of the track cleaning device for engaging, dislodging, and directing debris from between the respective track assembly and chassis of the work vehicle.

13. The off highway vehicle of claim 12 in which said frame of each track cleaning device including upper and lower arcuate walls; said chain assembly of each track cleaning device being an endless chain with an upper leg section thereof movable along an upper surface of the upper arcuate wall and a lower leg section movable along an upper surface of the lower arcuate wall.

14. The off highway vehicle of claim 13 in which the arcuate frame of each track cleaning device extends beyond forward and rear sides of the powered roller of the respective track assembly.

15. The off highway vehicle of claim 12 in which said motor of each said track cleaning device is mounted on the frame of the track cleaning device.

16. The off highway vehicle of claim 12 in which said chain assembly of each track cleaning device includes a pair of link chains having a plurality of cross members disposed between the link chains.

17. The off highway vehicle of claim 14 in which said cross members of each track cleaning device have pointed edges for engaging, dislodging, and directing debris from the gap between said track assembly and chassis.

18. The off highway vehicle of claim 15 in which said cross members of each track cleaning device are rectangular or square in cross section with corners thereof defining the pointed edges.

19. The off highway vehicle of claim 1 in which said frame of each track cleaning device includes a tensioning mechanism for biasing the chain supported thereon in a taught condition.

20. The off highway vehicle of claim 19 in which said frame of each track cleaning device has a main section mounted on said chassis supporting a plurality of said chain sprockets at one end and a relatively movable housing section supporting chain supporting a plurality of said chain sprockets at an opposite end of the frame, and said chain tensioning mechanisms each include a spring mechanism interposed between said main frame section and movable frame section of the respective track cleaning device for biasing the movable frame section in a direction that tensions the chain.
